(19) United States
(12) Patent Application Publication
(10) Pub. No.: US 2026/0266667 A1
(43) Pub. Date: Sep. 10, 2026

(54) TEMPERATURE MEASUREMENT SYSTEM WITH HERMETICALY SEALED THERMOGRAPHIC PHOSPHOR

(71) Applicant: ACCELOVANT TECHNOLOGIES CORPORATION, North Vancouver (CA)

(72) Inventors: Noah John Joe Johnson, North Vancouver (CA); Ondrej Mecl, North Vancouver (CA); James William Wiltshire Garrow, North Vancouver (CA); Michael William Goldstein, North Vancouver (CA); Petar Dimitrov Geroev, North Vancouver (CA)

(21) Appl. No.: 19/666,260

(22) Filed: May 3, 2026

Related U.S. Application Data
(63) Continuation of application No. 19/196,877, filed on May 2, 2025, now abandoned.
(60) Provisional application No. 63/650,320, filed on May 21, 2024.

(51) Int. Cl. G01K 11/32; G01K 1/08; G01K 11/20

(52) U.S. Cl. CPC G01K 11/32; G01K 1/08; G01K 11/20

(57) ABSTRACT

Examples of a system and method for temperature measurements with hermetically sealed sensing material. The system comprises a sensing tip optically connected to a fiber optic probe. The sensing tip comprises a housing with a cavity formed within the housing. The sensing material is positioned within the cavity. An optically transparent element is covering the cavity and held the sensing material within the cavity. The cavity is further hermetically sealed using a seal connected to at least a part of a lower surface of the optically transparent element.

### TECHNICAL FIELD

The present disclosure generally relates to a temperature measuring system and more particularly to a temperature measuring system using hermetically sealed sensing tip with phosphor therein.

### BACKGROUND

Unless otherwise indicated herein, the materials described in this section are not prior art to the claims in this application and are not admitted to be prior art by inclusion in this section.

Fiber optic temperature measuring systems use luminescence emitted from a sensing material (e.g., phosphor) to determine the temperature of an object that is in contact with the sensing material. Typically, thermographic phosphors when excited with light within a certain wavelength range, emit a light within a different wavelength range. Certain characteristics of the emitted light change with temperature including brightness, color, and afterglow duration. The response of the emitted light to temperature is monitored by various methods, such as analyzing the change in emission intensity at a single wavelength range or the change in intensity ratio of two or more wavelength ranges, lifetime decay, or shift in emission wavelength peak.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure. Sizes and relative positions of elements in the drawings are not necessarily drawn to scale. For example, the shapes of various elements and angles are not drawn to scale, and some of these elements are arbitrarily enlarged and positioned to improve drawing legibility.

FIG. 1A is a cross-sectional perspective partial view of an example of a temperature measuring system of the present invention with a hermetically sealed sensing tip connected to a temperature measuring probe.

FIG. 1B is a cross-sectional perspective partial view of another example of a temperature measuring system of the present invention with a hermetically sealed sensing tip embedded into a measuring object.

FIG. 2 is a cross-sectional partial view of one embodiment of a hermetically sealed sensing tip with an optically transparent window.

FIG. 3 is a cross-sectional partial view of another embodiment of a hermetically sealed sensing tip with an optically transparent window.

FIG. 4 is a cross-sectional partial view of an embodiment of a hermetically sealed sensing tip with an optically transparent cup creating a cavity to hold a sensing material.

FIG. 5 is a cross-sectional partial view of an embodiment of a hermetically sealed sensing tip with an optically transparent cup and multiple sensing material cavities.

### SUMMARY

In one aspect, fiber optic temperature measuring system with hermetically sealed sensing material) is provided. The system comprises a fiber optic probe with an elongated probe shaft and a lightguide within the probe shaft to convey an excitation light from a light source to a sensing material and an emitted light from the sensing material r to a detector. The system further comprises a sensing tip optically connected to a second end of the probe. The sensing tip comprises a housing and a cavity formed within the housing such that the sensing material is within the cavity. An optically transparent element is configured to cover the cavity and hold the sensing material within the cavity. The cavity with the sensing material therein is hermetically sealed using a seal connected to at least a part of a lower surface of the optically transparent element.

In one aspect, the optically transparent element is a window shaped and sized to fit tightly within the housing of the sensing tip such that a peripheral side wall of the window is abutting an inner surface of a housing side wall. The system further comprises a bonding layer positioned at a second side of the cavity such that a portion of the sensing material close and in contact with the bonding layer is adhered to the bonding layer while the sensing material close to a first measuring side is unbonded.

In another aspect, the optically transparent element is a cup with a top wall and a side wall connected to the top wall and extending away of the top wall and defining the cavity of the sensing tip. The optically transparent cup is shaped and sized to tightly fit in the housing of the sensing tip. The seal is positioned at a bottom of the housing of the sensing tip between an end of the side wall of the cup and the bottom of the sensing tip.

In another aspect, the optically transparent element is a cup with a top wall and two or more side walls connected to the top wall and extending away of the top wall and defining two or more cavities. Each of the cavities is adapted to hold sensing material. The seal is positioned at a bottom of the housing of the sensing tip between an end of the two or more side walls of the cup and the bottom of the sensing tip. The sensing material in one cavity of the two or more cavities has optical properties that are different from the optical properties of the sensing material in another cavity of the two or more cavities.

In addition to the aspects and embodiments described above, further aspects and embodiments will become apparent by reference to the drawings and study of the following detailed description.

### DETAILED DESCRIPTION OF SPECIFIC EMBODIMENTS

The present invention provides a hermetically sealed sensing material (e.g., thermographic phosphor) fiber optic temperature measurement system that overcomes the sensitivities and instabilities associated with the phosphor-binder composites when used in high temperature sealed environments. The hermetically sealed thermographic phosphor is and held in place mechanically using an optically transparent element, such as for example, a window, which is then hermetically sealed. In one embodiment, the thermographic phosphor is mechanically held on one side with an optical window, while on the other side is held using a binder. In yet another embodiment, the thermographic phosphor is mechanically held in an optical window shaped as a cup with a cavity allowing for simultaneously achieving hermetic seal and surface binding of the sensing material in a single step, allowing for less manufacturing steps and higher yields.

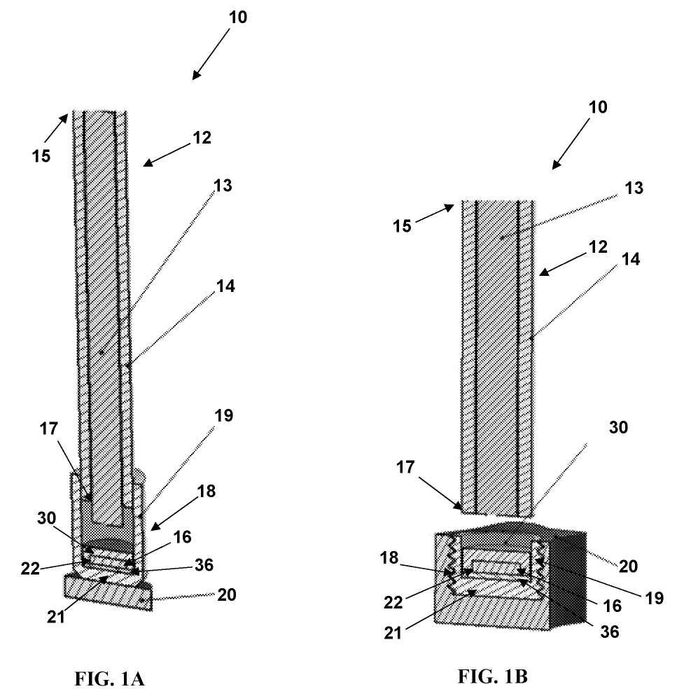

FIG. 1 illustrates an example of a temperature measuring system 10 that comprises a fiber optic probe 12 with an elongated probe shaft 14 that has a lightguide 13 within the probe shaft 14 to convey an excitation light from a light source (not shown) to a sensing material (e.g., phosphor) 16 and an emitted light from the sensing material 16 to a detector (not shown). The fiber optic probe 12 has a first end 15 operatively coupled to the light source and the detector and a second end 17. A sensing tip 18 is coupled to the second end 17 such that when a light is transmitted through the lightguide 13 it excites the active/sensing material 16 positioned in the sensing tip 18, in order to conduct temperature measurements in an environment/object 20 in proximity to the sensing tip 18.

The light source is in communication with the lightguide 13 so that the excitation light enters therein and is transmitted to the phosphor 16. The detector is in communication with the lightguide 13 so that the light emitted from the phosphor 16 is transmitted to the detector. The lightguide 13 can transmit both the excitation and the emitted light. The lightguide 13 can comprise a plurality of optical fibers arranged in parallel configuration in a fiber bundle, or it can be a single fiber bundle core. The fiber bundle core can be glass or polymer (plastic) optical fiber(s). A fiber bundle splitter can be provided, in one implementation, to split a single fiber bundle into an excitation light guide and an emitted light guide thus allowing to use one portion of a fiber bundle as a path to deliver excitation light to the phosphor 16 and using the remaining portion of the fiber bundle to guide the emitted light back to the detector. In one embodiment, the fiber bundle can comprise a separate excitation light guide align with the light source and an emitted light guide align with the detector. The light source can be a laser or a LED that is configured to provide excitation light in the blue to green wavelength range (e.g. 350 – 550 nm). In one embodiment, the light source can provide excitation light in the UV waveband between 200-400 nm. The detector is configured to receive the light emitted during the temperature measuring mode. In one implementation, the detector can be a photodiode. The photodiode can convert the optical signal (emitted/reflected light) into an analog electrical signal. The photons absorbed by the photodetector (e.g. photodiode) generate an electrical current. In some embodiments, the detector can be LED (P/N semiconductor) that can detect the optical signal (emitted/reflected light) by generating a photocurrent similarly as a photodiode. In one implementation, the electrical signal can be intensified using an amplifier (not shown) and then the analog electrical signal can be digitized using an A/D converter (not shown).

FIG. 1A illustrates sensing tip 18 wherein the housing 19 of the sensing tip 18 is connected to the shaft 14 of the fiber probe 12 in proximity to the second end 17, such that the bottom 21 of the housing 19 of the sensing tip 18 is in contact with a surface of the temperature measuring object 20 during temperature measurements. The second side 26 of the cavity 22 provides a thermal interface with the sensing tip 18 and the measuring object 20.

FIG. 1B illustrates sensing tip 18 wherein the housing 19 of the sensing tip18 is embedded in the temperature measuring object 20.

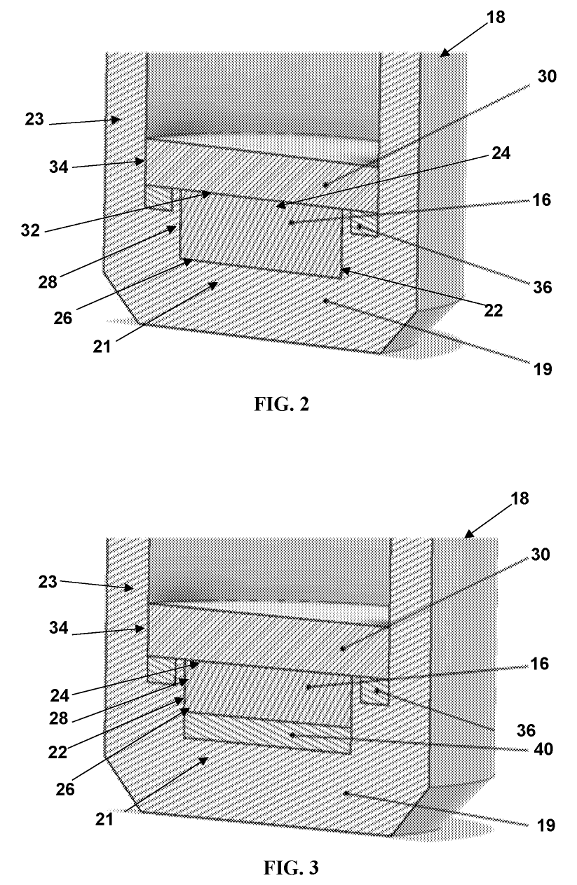

The sensing tip 18, embodiments of which are illustrated in detail in FIGS. 2 – 5, is optically connected to the second end 17 of the probe 12 and comprises a housing 19, with a cavity 22 formed within the housing 19. The housing 19 can be made of any suitable ceramic or metal. FIGS. 2 and 3, show the cavity 22 that is formed at a bottom 21 of the housing 19 and has a first measuring side 24, a second side 26, and side wall 28 extending between first measuring side 24 and the second side 26. The thermographic phosphor 16 is held in the cavity 22. An optically transparent element 30 is configured to cover the cavity 22 and held the thermographic phosphor 16 within the cavity 22. The first side 24 of the cavity 22 is completely covered with at least a portion of a lower surface 32 of the optically transparent element 30. A seal 36 is connected to at least a part of the lower surface 32 of the optically transparent element 30 to hermetically seal the cavity 22 with the thermographic phosphor 16 therein. The optically transparent element 30 is between the second end 17 of the probe 12 and the cavity 22 with the thermographic phosphor 16, such that the optically transparent element 30 and the thermographic phosphor 16 are spaced apart from the second end 17 of the probe 12.

The optically transparent element 30 illustrated in FIGS. 2 and 3, is a window shaped and sized to fit tightly within the housing 19 of the sensing tip 18 such that a peripheral side wall 34 of the window 30 is abutting an inner surface of a housing side wall 23. The window 30 can be an optically transparent glass, quartz or sapphire. The seal 36 is positioned between the side wall 28 of the cavity 22 and the peripheral wall 34 of the window 30. The seal 36 is chosen from a material depending on the measurement environment. For example, in a low temperature environment, the seal can be a rubber or a polymer seal, while for a high temperature environment, the seal is a glass frit bonding, for example.

In one embodiment of the sensing tip 18, illustrated in FIG. 3, a bonding layer 40 can be positioned at the second side 26 of the cavity 22, such that a portion of the thermographic phosphor 16 close and in contact with the bonding layer 40, at the thermal interface, can be adhered to the bonding layer 40 while the thermographic phosphor 16 close to the first measuring side 24 is still unbonded. This can provide better thermal response for the sensing tip 18 at the thermal interface at the second side 26. The bonding layer can be an inorganic glass, such as for example a glass frit bonding layer for systems used in high temperature environments, or an organic adhesive for systems operating in environments below 200 ^{o}C.

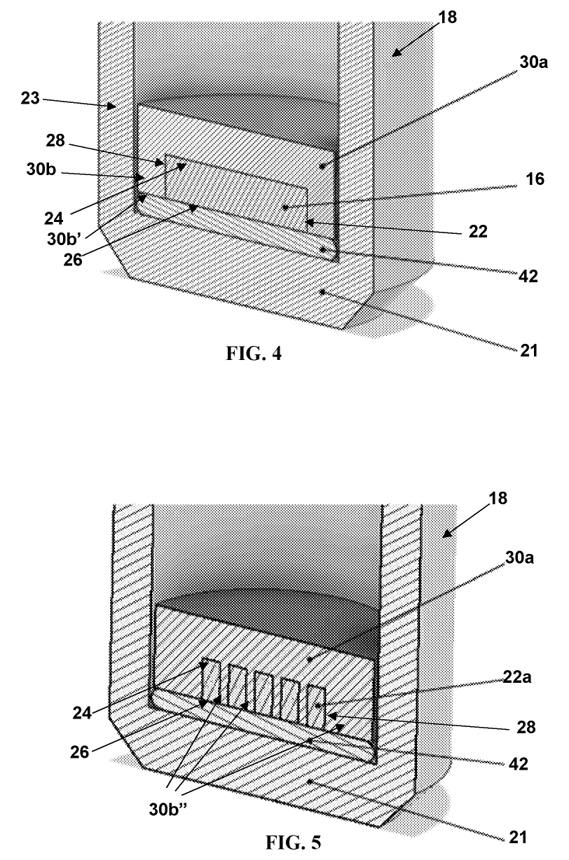

In an embodiment of the sensing tip 18 shown in FIG. 4, the optically transparent element is a cup 30 with a top wall 30a and side wall 30b connected to the top wall 30a and extending away of the top wall 30a and defining the cavity 16. The cup 30 is shaped and sized to tightly fit in the housing 19 of the sensing tip 18 such that the side wall 30b of the cup 30 is abutting an inner surface of the housing side wall 23. In this embodiment, the cavity 16 is defined by the cup shape and cup’s top wall 30a and side wall 30b, such that cavity first measuring side 24 is defined by a lower surface of the top wall 30a of the cup 30, its second side 26 is defined by a portion of the bottom 21 of the housing 19 of the sensing tip 18 and its side wall is defined by an inner surface of the side wall 30b of the cup 30. The cavity 16 can be sealed by a seal 42 that is positioned at the bottom 21 of the housing 19 of the sensing tip 18 between an end 30b’of the side wall 30b of the cup 30 and the bottom 21 of the sensing tip 18. The seal 42 can extend across the bottom 21 of the housing 19 of the sensing tip 18 to act as bonding layer to the portion of the thermographic phosphor 16 close and in contact with the seal 42 at the thermal interface 26 of the cavity 22, as well as to hermetically seal the cavity 22.

FIG. 5 illustrates another embodiment of the sensing tip 18 wherein the optically transparent element 30 is also cup with top wall 30a and two or more side walls 30b” connected to the top wall and extending away of the top wall 30a and defining two or more cavities 22a. Each of the cavities 22a can hold thermographic phosphor 16 with different optical properties. For example, the sensing tip 18 can have two separate cavities 22a’ and 22a”. The thermographic phosphor held in one of the cavities, e.g., 22a’, can have optical properties for measuring temperatures in one environment while the thermographic phosphor positioned in the other of the cavities, e.g., 22a”, can have optical properties for measuring temperatures in different environment. Similar to the embodiment of FIG. 4, the seal 42 can be positioned at the bottom 21 of the housing 19 of the sensing tip 18 between an end of the two or more side walls 30b of the cup 30 and the bottom 21 of the sensing tip18.

When the thermographic phosphor held in the cavity 22 is illuminated with such excitation light it will emit fluorescence light in the red wavelength range of 600 – 800 nm. The response of the emitted light to temperature is monitored by various methods, such as analyzing the change in emission intensity at a single wavelength range or the change in intensity ratio of two or more wavelength ranges, lifetime decay, or shift in emission wavelength peak.

While particular elements, embodiments and applications of the present disclosure have been shown and described, it will be understood, that the scope of the disclosure is not limited thereto, since modifications can be made by those skilled in the art without departing from the scope of the present disclosure, particularly in light of the foregoing teachings. Thus, for example, in any method or process disclosed herein, the acts or operations making up the method/process may be performed in any suitable sequence and are not necessarily limited to any particular disclosed sequence. Elements and components can be configured or arranged differently, combined, and/or eliminated in various embodiments. The various features and processes described above may be used independently of one another, or may be combined in various ways. All possible combinations and sub-combinations are intended to fall within the scope of this disclosure. Reference throughout this disclosure to “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this disclosure are not necessarily all referring to the same embodiment and may refer to one or more of the same or different embodiments.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without operator input or prompting, whether these features, elements and/or steps are included or are to be performed in any particular embodiment. No single feature or group of features is required for or indispensable to any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The example calculations, simulations, results, graphs, values, and parameters of the embodiments described herein are intended to illustrate and not to limit the disclosed embodiments. Other embodiments can be configured and/or operated differently than the illustrative examples described herein.

1. Fiber optic temperature measuring system with hermetically sealed sensing material comprising:
1a. a fiber optic probe having an elongated probe shaft and a lightguide within the probe shaft to convey an excitation light from a light source to a sensing material and an emitted light from the sensing material to a detector, the fiber optic probe having a first end and a second end; and
1b. a sensing tip optically connected to the second end of the probe, the sensing tip comprising a housing; a cavity formed within the housing and having a first measuring side, a second side, and side wall extending between first measuring side and the second side; the sensing material within the cavity, an optically transparent element having an upper surface and a lower surface and adapted to cover the cavity and held the sensing material within the cavity such that the first side of the cavity is completely covered with at least a portion of the lower surface of the optically transparent element, and a seal connected to at least a part of the lower surface of the optically transparent element to hermetically seal the cavity with the sensing material, wherein the optically transparent element is between the second end of the probe and the cavity with the sensing material and spaced apart from the second end of the probe.

2. The fiber optic temperature measuring system of claim 1, wherein the optically transparent element is made of a sapphire, glass, or quartz.

3. The fiber optic temperature measuring system of claim 1, wherein the seal is a glass frit bonding.

4. The fiber optic temperature measuring system of claim 1, wherein the seal is a rubber or a polymer.

5. The fiber optic temperature measuring system of claim 1, wherein the housing of the sensing tip is a ceramic or a metal.

6. The fiber optic temperature measuring system of claim 1, wherein the optically transparent element is a window shaped and sized to fit tightly within the housing of the sensing tip such that a peripheral side wall of the window is abutting an inner surface of a housing side wall, the seal positioned between the side wall of the cavity and the peripheral wall of the window.

7. The fiber optic temperature measuring system of claim 6, further comprising a bonding layer positioned at the second side of the cavity, a portion of the sensing material close and in contact with the bonding layer being adhered to the bonding layer while the sensing material close to the first measuring side is unbonded.

8. The fiber optic temperature measuring system of claim 7, wherein the bonding layer is an inorganic glass-based composition.

9. The fiber optic temperature measuring system of claim 1, wherein the optically transparent element is a cup with a top wall and a side wall connected to the top wall and extending away of the top wall and defining the cavity of the sensing tip, the cup being shaped and sized to tightly fit in the housing of the sensing tip such that such that the side wall of the cup is abutting an inner surface of a housing side wall, the seal being positioned at a bottom of the housing of the sensing tip between an end of the side wall of the cup and the bottom of the sensing tip, wherein the cavity first measuring side is defined by a lower surface of the top wall of the cup, its second side is defined by a portion of the bottom of the housing of the sensing tip and its side wall is defined by an inner surface of the side wall of the cup.

10. The fiber optic temperature measuring system of claim 9, further comprising a bonding layer positioned at the bottom of the housing of the sensing tip to seal the cavity and to adhere a portion of the sensing material close and in contact with the bonding layer.

11. The fiber optic temperature measuring system of claim 10, wherein the bonding layer is an inorganic glass-based composition.

12. The fiber optic temperature measuring system of claim 1, wherein the optically transparent element is a cup with a top wall and two or more side walls connected to the top wall and extending away of the top wall and defining two or more cavities, each of the cavities adapted to hold sensing material, the seal being positioned at a bottom of the housing of the sensing tip between an end of the two or more side walls of the cup and the bottom of the sensing tip.

13. The fiber optic temperature measuring system of claim 12, wherein the seal is a bonding layer positioned at the bottom of the housing of the sensing tip to seal the two or more cavities and to adhere a portion of the sensing material positioned in the two or more cavities that is close and in contact with the bonding layer.

14. The fiber optic temperature measuring system of claim 13, wherein the bonding layer is an inorganic glass-based composition.

15. The fiber optic temperature measuring system of claim 12, wherein the sensing material in one cavity of the two or more cavities have optical properties that are different from the optical properties of the sensing material in another cavity of the two or more cavities.

16. The fiber optic temperature measuring system of claim 1, wherein the housing of the sensing tip is connected to the shaft of the probe in proximity to the second end of the probe, a bottom of the housing of the sensing tip being in contact with a surface of a temperature measuring object during temperature measurements.

17. The fiber optic temperature measuring system of claim 1, wherein the housing of the sensing tip is embedded in a temperature measuring object.

18. The fiber optic temperature measuring system of claim 1, wherein the light source is a laser diode or is a light emitting diode (LED).

19. The fiber optic temperature measuring system of claim 18, wherein the light source provides excitation light in a wavelength range of 350 – 550 nm.
